(19) United States
(12) Patent Application Publication
(10) Pub. No.: US 2019/0073606 A1
(43) Pub. Date: Mar. 7, 2019

(54) DYNAMIC CONTENT OPTIMIZATION

(71) Applicant: Wylei, Inc., Jersey City, NJ (US)

(72) Inventors: Margaret Columbia-Walsh, Verona, NJ (US); Guy Dubrovski, Tel Aviv (IL); Mitchell Skomra, Buffalo, NY (US)

(21) Appl. No.: 15/694,146

(22) Filed: Sep. 1, 2017

(51) Int. Cl. G06N 99/00; G06Q 50/00

(52) U.S. Cl. CPC G06N 99/005; G06Q 50/01

(57) ABSTRACT

Disclosed embodiments include systems and methods relevant to optimization of dynamic content. For example, disclosed embodiments can involve generating dynamic content based on the performance of content variants. The performance of content variants can be analyzed and used as input to a machine learning framework that allows for the creation of variants configured to optimize for goal parameters. In some examples the machine learning framework can include the use of greedy algorithms, discrete hill climbing algorithms, and evolutionary algorithms among others.

### BACKGROUND

A variety of platforms specialize in providing content, including social media platforms, news platforms, content discovery platforms, and entertainment platforms, among others. Platforms can provide content in a variety of ways, including through a web browser or another application (e.g., a smartphone app). These platforms traditionally provide non-customized content to visitors and can provide viewership statistics to content authors. There exists a need in the art for an improved way to optimize content for audiences.

### SUMMARY

In general terms, this disclosure is relevant to the optimization of dynamic content. For example, disclosed embodiments can involve generating dynamic content based on the performance of content variants. The performance of content variants can be analyzed and used as input to a machine learning framework that allows for the creation of variants configured to optimize for goal parameters. In some examples the machine learning framework can include the use of greedy algorithms, discrete hill climbing algorithms, and evolutionary algorithms, among others.

In one aspect, the disclosed technology relates to a method for generating video content, including: obtaining authored content; generating a first content variant based in part on the authored content; rendering a first video output based on the first content variant; receive performance statistics associated with audience reception to the first video output; using a machine learning framework to generate a second content variant based in part on the performance statistics; and rendering a second video output based on the second content variant. In one embodiment, the method further includes providing the first video output to a media-delivery platform, wherein the performance statistics are received from the media-delivery platform. In another embodiment, the machine learning framework is configured to optimize with respect to a goal associated with an audience. In another embodiment, the machine learning framework to generate the second content variant includes applying a greedy algorithm. In another embodiment, the greedy algorithm is a discrete hill climbing algorithm. In another embodiment, the machine learning framework to generate a second content variant includes applying an evolutionary algorithm. In another embodiment, the first content variant is generated using a subset of the authored content. In another embodiment, the first content variant includes a first video clip of the authored content and not a second video clip of the authored content.

In another aspect, the disclosed technology relates to a computer-implemented method including: generating a plurality of content variants; rendering content items for each of the plurality of content variants; uploading the rendered content items to a media-distribution platform; obtaining performance statistics regarding performance of the uploaded content; providing the performance statistics as input to a machine learning framework; generating at least one new content variant based on output of the machine learning framework; and uploading the at least one new content variant to the media-distribution platform. In one embodiment, the computer-implemented method further includes obtaining authored content, wherein the plurality of content variants are generated based on the authored content. In another embodiment, the content variants each include a subset of the authored content. In another embodiment, the computer-implemented method further includes deactivating an uploaded content item on the media-distribution platform responsive to determining that the uploaded content item is a poor performing content item. In another embodiment, the computer-implemented method further includes waiting for a statistically significant convergence prior to providing the performance statistics as input to the machine learning framework. In another embodiment, the computer-implemented method further includes waiting for a number of events to exceed a threshold and for a minimum time period prior to providing the performance statistics as input to the machine learning framework.

In another aspect, the disclosed technology relates to a computer-implemented method including: obtaining authored content including a plurality of options, each option having a plurality of possible values; for each option of the plurality of options, selecting a value from the respective plurality of possible values; generating an initial video variant based, in part, on the possible values; selecting a first option of the initial video variant; generating a new variant for each of the plurality of possible values of the option; and rendering a plurality of videos using the generated new variants. In one embodiment, the computer-implemented method further includes testing the performance of the plurality of videos. In another embodiment, testing the performance of the plurality of videos includes determining whether a video of the plurality of videos has a statistically significant probability of success with respect to a predetermined goal. In another embodiment, the computer-implemented method further includes, responsive to determining that a video of the plurality of videos has a statistically significant probability of success, selecting a second value associated with a second option of the video; and setting the second option of the initial video variant to the second value. In another embodiment, selecting the value from the plurality of possible values includes selecting the value at random. In another embodiment, the computer-implemented method further includes rendering an initial video based on the initial video variant; and obtaining statistics regarding the performance of the initial video.

### BRIEF DESCRIPTION OF THE DRAWINGS

FIG. 1 illustrates an example system for providing dynamic content from a content authoring device to one or more audience devices.

FIG. 2 illustrates an example process for creating content output.

FIG. 3 illustrates an example process for updating variants based on statistics.

FIG. 4 illustrates an example process for optimizing content.

FIG. 5 illustrates an example process for optimizing content based, in part, on variant options and values.

FIG. 6 illustrates an example process for determining performance of variants.

FIG. 7 illustrates an example computing system with which disclosed systems and methods can be used.

### DETAILED DESCRIPTION

Disclosed embodiments generally relate to technological improvements that allow for automated optimization of dynamic content.

Traditional content optimization is a manual process, if it is performed all. For example, prior to the release of a movie or other video, the video may be screened to a test audience or focus group in order to solicit feedback to make improvements to the film. However this is a manual process involving manually showing the video to the audience and manually making edits and updates to the film. This process often involves testing only a few variants and may nonetheless fail to provide a statistically-detectable level of improvement. The screening processes are often time-consuming and labor-intensive and limit the effectiveness of content optimization.

Disclosed embodiments allow for improvement over traditional optimization techniques. For example, disclosed embodiments allow for the testing of multiple variants of content and allow for the generation of content variants using machine learning. Further, disclosed embodiments involve technological improvements that allow for computer automation of content optimization. In addition, disclosed embodiments improve the functioning of computers performing such optimization. For example, the speed at which an optimal variant can be determined can be improved by identifying and removing poor performing variants during the optimization process. This technique can allow for the fast pruning of variants in order to find optimal variants without going over all the variants.

In an example, a content-optimizing process involves receiving content from an author, generating a content output using a subset of the content, and gathering statistics regarding the performance of the generated content output. The statistics are then used to optimize the generation of future content output using subsets of the content received from the author.

In a further example, testing of a large number of variants can be facilitated to optimize performance of the content for particular audience. The performance of the content be measured in a variety of ways, including indications of how audience members reacted to the content (e.g., whether audience members enjoyed the content). An indication of how audience members react to the content be measured in a variety of ways. In an example, the indication can be based on an audience member activating a user interface element for saving, rating, bookmarking, sharing, reacting to, commenting on, “starring”, “hearting”, or “liking” the content. In another example, the indication can be based on audience engagement, such as how long an audience member spent with the content (e.g., how long an audience member viewed the content, the percentage of the overall content that the audience member viewed, etc.). The performance of the content can also be measured based on indications that the audience members have taken an action with respect to the content. Actions can include, accessing a link associated with the content (e.g., a link to a location with more information regarding the presented content) or sharing the content with others. The actions can also include actions taken by an audience member elsewhere (e.g., at a different website, on a different application, in a physical location, etc.).

Some examples disclosed herein describe the application of dynamic content optimization to particular kinds of content (e.g., video content), but the techniques disclosed herein can be applicable to a variety of different kinds content or combinations of kinds of content, including but not limited to video content, interactive content, static visual content (e.g., images or text), and audio content.

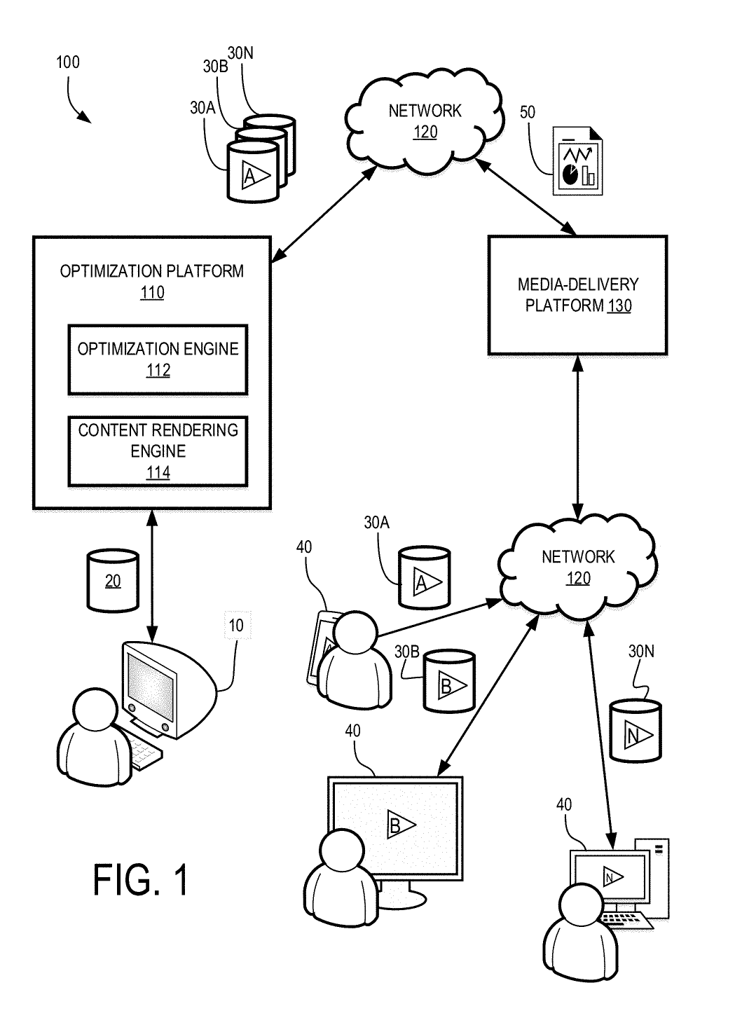

FIG. 1 illustrates an example system 100 for providing dynamic content from a content authoring device 10 to one or more audience devices 40. The system includes an optimization platform 110 connected over a network 120 to a media-delivery platform 130, which provides content to the one or more audience devices 40.

When a content author wants to provide dynamic content, the author can use the content authoring device 10 to generate authored content 20 that can form the basis of the dynamic content. The content authoring device 10 can be any computing device suitable for creating content, such as a smart phone, a tablet, a personal computer, or other device.

The authored content 20 can include a collection of content for providing to an audience. For example, the collection of content can include one or more files containing content data suitable for presentation to an audience. For instance, where the authored content 20 comprises video content, it can also include data regarding composited elements of the video (e.g., text to be overlaid on the video, visual elements to be composited on the video, etc.). The authored content 20 can also include several different video clips to be combined together to form a final video, as well as data regarding how the authored content can or should be combined to form a final video to be distributed to an audience. Where the authored content 20 is an article, the authored content can include data regarding a headline, a sub-headline, an associated image, and body text, among other data. In some examples, the content can be or use in conjunction with interactive content, such as mobile apps.

The authored content 20 can include more content than may appear in a content release for presenting to an audience. In this manner, the authored content 20 can support the creation of multiple variations from which a content release can be rendered. For example, where the authored content 20 is video, it can include multiple different backing tracks, title overlays, video descriptions, thumbnail images, clips, and other content components, a subset of which can be selected to form a variant. The variant can then form a specification that describes how the authored content can be combined by a content renderer to form a final piece of content. The authored content 20 can also include descriptions, rules, or suggestions regarding how to combine the authored content to form a content release. For example, the authored content 20 can include content labeled as beginning content, middle content, and end content, and can include a rule indicating that a single one of each is to be selected and combined in a particular order.

The authored content 20 can also include information regarding how the content is to be distributed. For example, the authored content 20 can include information regarding with which one or more media-delivery platforms 130 a content release is to be provided. The authored content 20 can also include information regarding a desired audience for the content release. For example, the authored content 20 can include information regarding particular content meant for particular audiences. For example, a visual content release may have an overlay text including a phone number, and the authored content 20 can include multiple different phone numbers for different audiences in different geographies (e.g., an international phone number, a local telephone number, a toll-free telephone number, etc.).

The content author can upload the authored content 20 from the content authoring device 10 to the optimization platform 110.

The optimization platform 110 can include a variety of components including an optimization engine 112 and a content rendering engine 114. As will be described in more detail below, the optimization engine 112 is a component configured to optimize to-be-released content. The optimization engine 112 can optimize the content based on a variety of goals, which may depend on the content's type (e.g., text, audio, video, interactive, etc.). Typically goals are based on a degree of success of the content. For example, goals applicable to video content may include a number of views the content received, a total viewing time, or a number of actions taken with respect to the content (e.g., accessing a URL associated with the content, calling a phone number associated with the content, sharing the content on a social network, making a purchase associated with the content, etc.). The goals can be measured in a variety of ways, such as through a content-delivery platform or through associated third parties. These measurements can include measurements of website traffic and physical store visits, among other measurements. The optimization engine 112 can make optimizations using a variety of techniques including but not limited to machine learning algorithms.

The optimization engine 112 can take in a variety of different inputs on which to base the optimization. These inputs can include information regarding the performance of a particular content with respect to the desired goals, information provided in the authored content 20, other input for directing optimization (e.g., as provided by an administrator of the optimization platform 110), or other input. In an example, the inputs can include data acquired after receiving the authored content 20. For instance, the optimization engine 112 can acquire data regarding a current stock price, a current flight status, current weather conditions, a current sports team score, or other data for inclusion in the rendered content or to influence the creation of the rendered content. If the optimization engine 112 obtains data indicating that a particular team won a sporting event, then the optimization engine 112 can direct a particular kind of content to be rendered that is different than if another team had won. Based on optimization output from the optimization engine 112, the optimization engine can direct the content rendering engine 114 to render a particular output content based on the authored content 20.

The content rendering engine 114 is a component configured to render to-be-delivered content based on the authored content 20. The content rendering engine 114 can be controlled over an application programming interface (API). For example, the optimization engine 112 can direct the creation of the to-be-be delivered content using the content rendering engine 114 over an API. The rendered content can be content combining a subset of the content from the authored content 20. For example, the content rendering engine 114 can receive a variant (or an identifier associated with a variant) describing content to include in video content and render the to-be-delivered video based thereon.

The optimization platform 110 can provide one or more content releases 30A, 30B, . . . , 30N (collectively, the one or more content releases can be referred as content releases 30) for hosting at the media-delivery platform 130.

The media-delivery platform 130 is a platform for providing media content to an audience. The media-delivery platform 130 can be a video hosting service (e.g., YOUTUBE), an audio hosting service (e.g., SOUNDLCOUD), a live video streaming service (e.g., TWITCH), a social media platform (e.g., FACEBOOK, INSTAGRAM, SNAPCHAT, PINTEREST, or TWITTER.), marketing platforms (e.g., custom website banner providers, OUTBRAIN, or TABOOLA), messaging platforms (e.g., SLACK, IMESSAGE, WECHAT, KIK, WHATSAPP, or FACEBOOK MESSENGER), electronic billboard platforms, or other platforms for providing media content. The media-delivery platform 130 can receive the one or more content releases 30 from the optimization platform 110 and make the content releases 30 available to audience devices 40. In some examples, different content releases 30 are provided to different audiences. For example, the media-delivery platform 130 may be configured to provide different content releases to different users depending on their demographic information (e.g., the location from which the user is accessing the content or other content related to the media-delivery platform 130), to different users based on a time of day, or to different users at random. In some examples, other mechanisms may be used to determine which content releases 30 are provided.

Although FIG. 1 illustrates a single media-delivery platform 130, there may be more than one. In some examples, the optimization platform 110 provides different content releases 30 to different media-delivery platforms 130. In some examples, different kinds of content can be provided to different media-delivery platforms 130. For example, an optimization platform 110 may release both audio content and video content based on the authored content 20 and these different kinds of content can be provided to different delivery platforms 130.

The media-delivery platform 130 can provide to statistics 50 or other metrics regarding the performance of the one or more content releases 30. The statistics 50 can vary based on the kind of content and the media-delivery platform 130. Generally, the statistics may include metrics regarding how many times the content was accessed, demographic-specific data (e.g., statistics regarding the audience that accessed the content for particular, such as age, gender, location, etc.), traffic specific data (e.g., the type of device used to access the content), data regarding how the user arrived at the content (e.g., from a particular website, a particular application, etc.), advertising performance metrics (e.g., where the content is or is associated with an advertisement, the statistics 50 can include: click-through rate, conversion rate, cost of advertisement, etc.), engagement metrics (e.g., a number of comments, favorites, likes, dislikes, bookmarks, shares, etc. that the video received), and other metrics.

The optimization platform 110 can automatically or periodically retrieve or receive the statistics 50 regarding the performance of the content releases 30. The optimization platform 110 can then provide the statistics 50 to the optimization engine 112, which can, in turn, use the statistics 50 to optimize future content. For example, the optimization engine 112 can evaluate how well different content variants are performing and decide which content variants should rendered and tested next and which variants should be turned off. The optimization engine 122 can cause the content rendering engine 114 to render or otherwise prepare new content releases based on content variants and upload the content releases to the media-delivery platform 130. By this process, the optimization platform 110 can iteratively improve content performance on desired metrics.

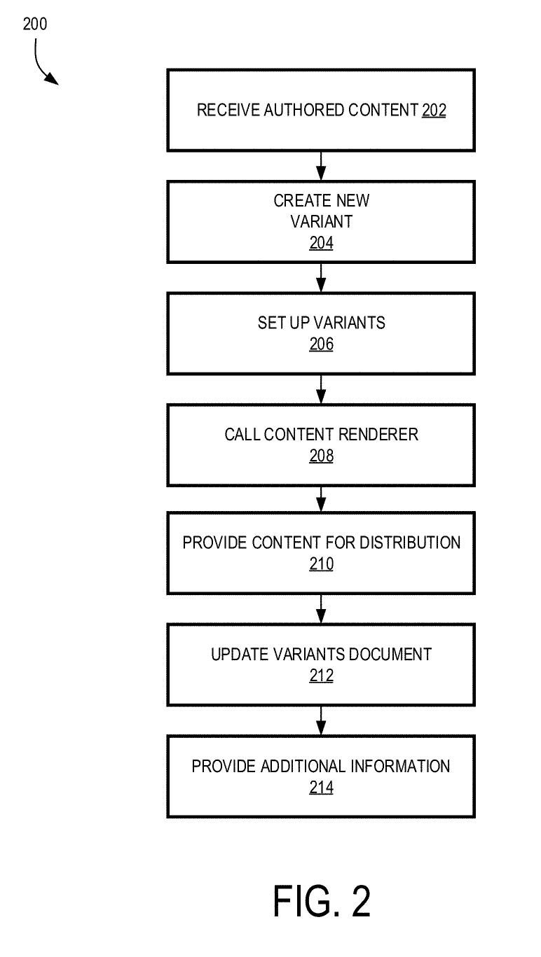

FIG. 2 illustrates an example process 200 for creating a content output (e.g., content releases 30).

The process 200 begins with operation 202, which involves receiving authored content. The authored content can be received from an authoring device, uploaded from a user's device, received from a server (e.g., received from a server hosting a content-authoring interface), or obtained from another source. In some examples, the authoring content can include information regarding a campaign associated with the authored content. This campaign information can include, for example, campaign budget information, ad set information, campaign objective information, and campaign creative information, among other campaign data. In addition, there can be an identifier associated with the authored content and or/the campaign information.

With the authored content received in operation 202, the process 200 can move to operation 204.

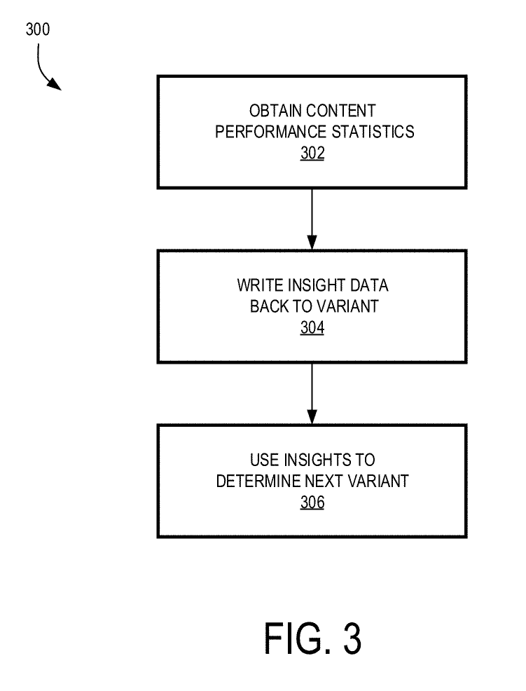

In operation 204, the process 200 can begin to create one or more content variants. This operation 204 can include receiving input from a machine learning framework regarding one or more variants. In an example, the content can be visual content and the variants can describe a specification for creating the content including customizations or options for content layers, as well as information regarding a campaign ID. As a particular example, the authored content received in operation 202 may include a visual content file having multiple layers that combine together to form the content. For instance, the layers may include a background photo layer, a title text layer, and a call-to-action text layer. The content of these layers may be fixed or variable. In some instances, the author may designate the layers or aspects of the layers as fixed or variable. In some instances, a machine learning framework may identify fixed or variable content within the layers and dynamically pull apart the aspects based on their identification. The variants may vary based on the content of the variable layers and may maintain same content for the fixed content layers. The information can be received over an API. Aspects of operation 204 are described in further detail with respect to FIG. 3.

In an example, the authored content, a previously-created variant, or other data is stored in a database or other data structure for later retrieval. The process 200 can further retrieve data from the authored content. This can include loading the content and other files associated with the authored content.

In operation 206, the process can include using the data retrieved from both the machine learning framework (e.g., as obtained in operation 202) and data retrieved from the authored content (e.g., as obtained at operation 204) to create a new content variant. The new content variant can include information specific to this variant (e.g., what subset of data from the authored content makes up the variant and in what format and in what way) as well as an identifier associated with this variant. The identifier can be used for unique identification of the variant, as well as for tracking purposes (e.g., to monitor the performance of the variant).

In operation 208, the process 200 can provide the variant ID or other data to the content renderer to create output content based on the variant. The renderer then creates the output based on the provided variant information. In an example, this can include collecting data associated with the authored content, combining the content together based on the variant, and providing the output in a suitable format for distribution. Where the variant describes video content, this can include combing clips of data, applying audio elements, and compositing text elements, among other tasks.

In addition, the content renderer can send an alert over an API indicating that the content is rendered. This can include, for example providing an identifier associated with the variant used to create the rendered content over the API. This information can then be stored in a database for later use.

In operation 210, the rendered content is provided to a media-delivery platform. Some media-delivery platforms will process content provided to them (e.g., scanning for copyrighted material). In some examples, the content is rendered and provided to the media-delivery platform with minimal delay between the content being rendered and the content being provided for distribution (e.g., in substantially real-time). In other examples, there may be a delay between the content being rendered and being presented. Such content may be stored for later use. And even in instances where there is minimal delay between rendering and distribution of content, the content may nonetheless be stored for later viewing or distribution. For instance, once the content output is produced, the renderer can cause the completed content to be stored in a storage area (e.g., a cloud storage provider such as AMAZON S3) for later use. In some examples, the completed content in storage is associated with a URL or other identifier that can be used to access the completed content. This URL can be written to a content variants document that includes metadata regarding content variants.

In operation 212, the content variants document can be updated with media-delivery platform data. The media-delivery platform data can include a variety of different kinds of data regarding a media-delivery platform associated with the variant.

In operation 214, any necessary additional information can be provided to the media-delivery platform 130. This can include, for example, any advertisement information for the variant, where the content is part of an advertising campaign.

FIG. 3 illustrates an example process 300 for updating content variants based on statistics. For example, a content optimization platform can obtain statistics or other data regarding the

At operation 302, the optimization platform can obtain statistics regarding the performance of content. This can include, for example, receiving from (e.g., being pushed) or polling the media-delivery platform or another platform that provides statistics regarding performance of media content. In an example, the optimization platform can periodically poll the media-delivery platform (e.g., every 15 minutes) to obtain new information regarding the performance of media content provided to the media-delivery platform.

At operation 304, data associated with the obtained statistics can be written to the storage (e.g., a variants database). In an example, this can include associating the statistics with a content identifier and or a creative identifier. In some examples, the data is written to an indexing and search platform (e.g., ELASTICSEARCH) for use by the machine learning engine or reporting.

For example, the stored statistics can be used for training the machine learning engine. In another example, a decisioning rule can be created by combining sampled data with historical sample data.

At operation 306, the optimization platform (e.g., a machine learning framework thereof) can use the obtained statistics to generate data for use in creating a next content variant that is further optimized to achieve a desired content goal. For example, the next time a content variant is to be created (e.g., as in operation 204), the content variant can be created based on the insights learned from the statistics.

In some examples, a machine learning framework is used to generate the optimized variant. Examples of using machine learning to determine future variants are described herein. In an example, a greedy algorithm can be used to explore the large combinatorial space of variants in a linear computational complexity applied to the content space. In an example, a discrete hill climbing algorithm can be used to estimate the value of each position in a batch of tests. In another example, an evolutionary algorithm can be used in which fit variants are identified, merged, and, in some instances, a random modification (“mutation”) can be applied.

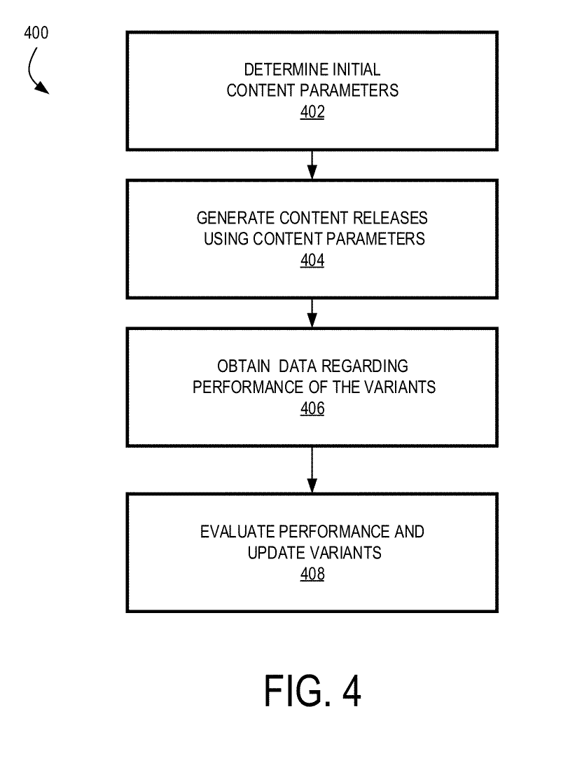

FIG. 4 illustrates an example process for optimizing content. The process 400 can begin with determining initial parameters. These parameters can be based on the authored content received from the authoring device. The initial content parameters can involve a selection of a subset of content parameters for the to-be-released content. For example this can include choosing from among possible color combinations for content, choosing from among different kinds of text for use in an overlay of the content, choosing a subset of clips for use in video or audio content, and choosing an order of clips to use in video or audio content, among other initial content parameters.

At operation 404, a content release can be generated with the content parameters chosen operation 402. This can involve, for example, sending the initial content parameters or a description thereof to the content rendering engine to produce a content release. Then the content release can be sent to the media distribution platform for distribution to an audience.

At operation 406 data regarding the performance of that content release (and the variant from which it was created) can be obtained from the media distribution platform. This may be performed by, for example, polling the platform, receiving the data automatically from the content platform, or inferring performance of the content from other sources (e.g., determining a click through rate of a link associated with the content). The data can be obtained in a live feed or in batches of data.

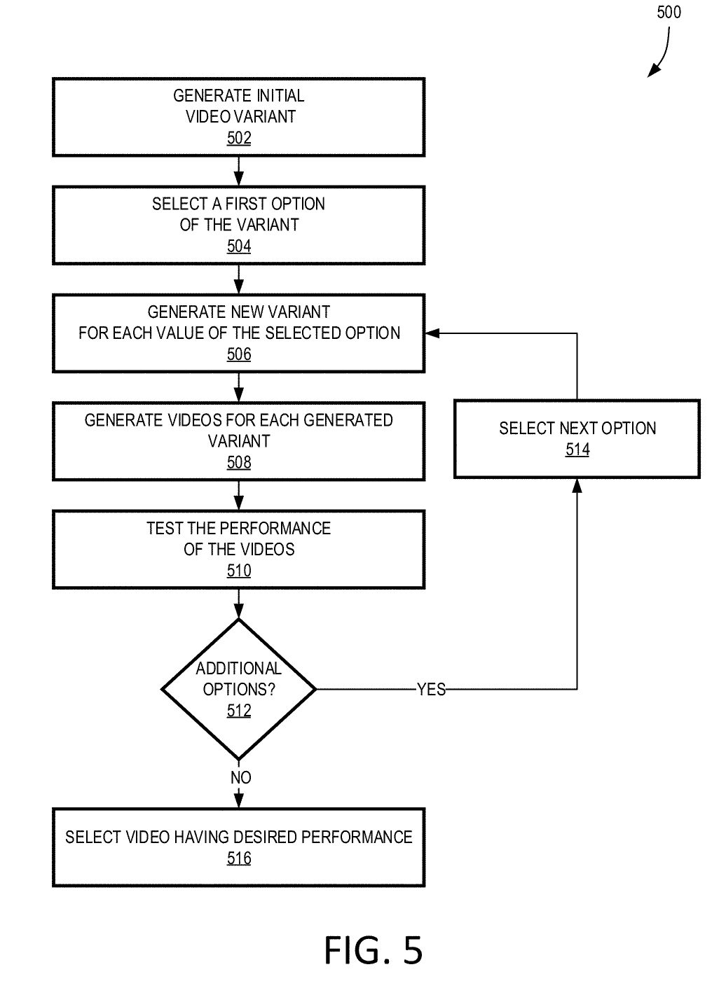

At operation 408, the performance of the content releases generated in operation 404 can be determined based on the performance the content release in operation 406. Based on this performance, the process 400 can be repeated with updated initial content parameters based on the performance of the variant as determined by the obtain statistics regarding the variant in operation 406. Additional details regarding example way that this process 400 can be performed is shown and described in FIG. 5. In another example, updating variants can involve disabling content on the media-delivery platform (e.g., “turning off” content). This can be in response to, for example, determining that the content is performing poorly compared to other variants. In yet another example, updating variants can involve keeping a content variant active on the media-delivery platform.

FIG. 5 illustrates an example process 500 for optimizing video content based, in part, on variant options and values, though a same or similar process can be applied to other kinds of content, such as static content, interactive content, or audio content. A machine learning framework can use a variety of different methods for producing video variants and updating the variants based on the obtained statistics.

Process 500 includes operation 502 involve generating in initial video variant. A video variant X can be considered to be composed of a set of values for all of its options. This can be expressed as X=(X₁, X₂, X₃, . . . , Xₙ), where each Xᵢ in the set X represents an option i for the video variant. Each Xᵢ can have its own value j. This can be expressed as xᵢ^{j}∈Xᵢ.

In a simple example, an example video variant Y has two options associated with a title card that appears before the video plays: title text color (e.g., Yₜₑₓₜ) and title card background color (e.g., Y_{bkg}). Each of these options can have a variety of different values, but for the purposes of the example, each color option can have a blue color option (e.g., y_{bkg}^{blue}), a white color option (e.g., y_{bkg}^{white}) and a black color option (e.g. y_{bkg}^{black}). The color options may be associated with, for example, a particular color value (e.g., an RGB color value). In this example, the video variant set Y can be expressed by: Y={y_{bkg}^{white},y_{bkg}^{blue},y_{bkg}^{black},y_{bkg}^{white},y_{bkg}^{blue},y_{bkg}^{black}}.

The video variant can be generated in a variety of ways. For example, generating the variant can include receiving a manual selection of a particular variant for testing (e.g., selecting a variant from an initial list of variants, such as selecting a previously used video variant from a list of historical video variants). In an example, generating the initial video variant can begin by generating a random video variant where each option is initialized to a random value. This can be expressed as: Xᵢₙᵢₜ=(x₁^{rand1}, x₂^{rand2}, . . . , xₙ^{randn}). In another example, elements of a provided benchmark video can be chosen.

The generated initial video variant can be tested to determine its performance. This can be done in a variety of ways, including but not limited to analyzing gathered statistics as previously described (e.g., operation 406).

Continuing the previous example, let's say the random video variant is: Yᵢₙᵢₜ={y_{bkg}^{black}, yₜₑₓₜ^{blue}}. This video can be uploaded to the media-delivery platform and tested to obtain statistics in regarding the video's performance with respect to audience satisfaction as measured by a number of likes the video received on a social network.

With the random variant initialized, the process can proceed to operation 504.

Operation 504 involves selection of a first option of the variant. As described above each variant can have a variety of different options (e.g., options corresponding to desired text color, fonts, clip order, selected clips, or other options for a variant). In operation 504, a first option i in Xᵢₙᵢₜ can be selected and variants of different values of the total number of value options k are generated while keeping the non-selected options static. For instance, a selected option can be isolated and all possible variants for that option are generated while keeping the non-selected options at initialized values.

Continuing the previous example, the first option selected can be the background color, which can be expressed as Y_{bkg}. The possible values of Y_{bkg} are white, blue, and black. The non-selected option is yₜₑₓₜ and so, keeping it the same as it was initialized, the value for the option is blue: yₜₑₓₜ^{blue}. Keeping yₜₑₓₜ static and generating all possible values of y_{bkg} results in the following set of variants: {{y_{bkg}^{white},yₜₑₓₜ^{blue}}, {y_{bkg}^{blue},yₜₑₓₜ^{blue}}, {y_{bkg}^{black},yₜₑₓₜ^{blue}}}.

As can be seen, one of the video variants xⱼ^{k} in the set is the same as the initialized variant. In the example, xⱼ^{k} would be {x_{bkg}^{black},xₜₑₓₜ^{blue}} because it is the same as the initialized, random video variant.

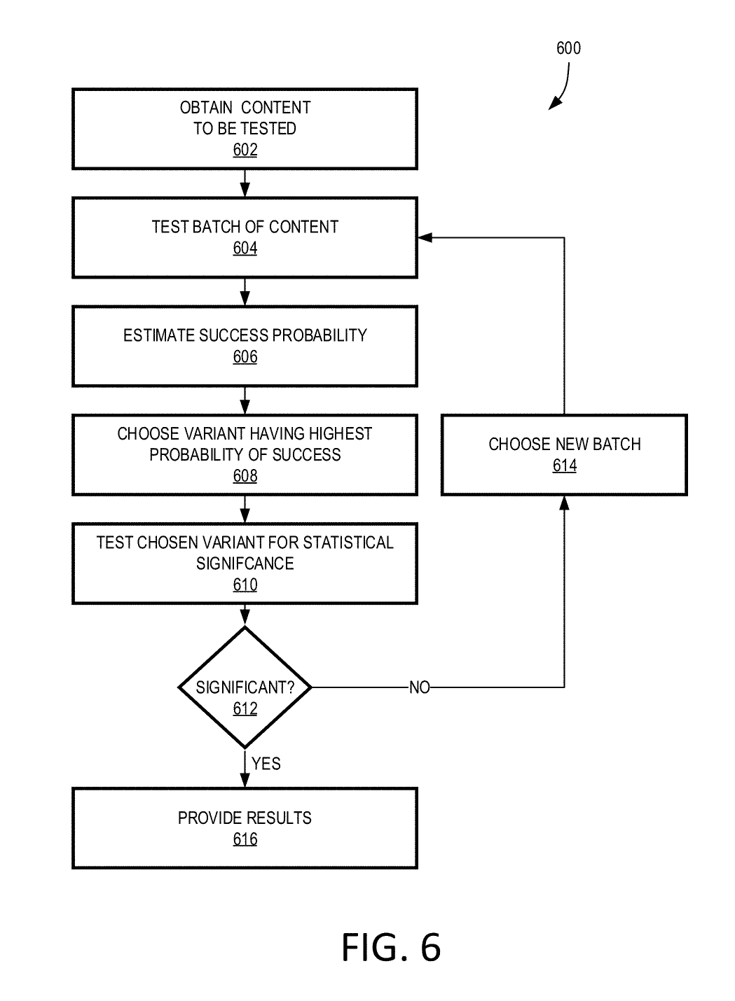

At operation 508 videos can be generated for each of the variants generated in operation 506. Next, in operation 510, the performance of the generated videos can be tested. In some examples, this involves the testing of all new videos (e.g., all vides other than 4). The testing of the generated videos can involve uploading the videos to a media-delivery platform and determining the performance of the video variants. This process is described in further detail in FIG. 6.

After the performance of the videos is tested, at operation 512 it is determined whether there are additional options that were not previously selected (e.g., see operations 504 and operation 514) if there are no further options, then the flow can move to operation 516. However, if there are additional options, then the flow can move to operation 514 where a next option can be selected and the flow moves back to operation 506.

At operation 516, having generated and tested variants, a video can be selected having a desired performance. For example, having generated various variants and tested their performance, it can be determined which of the generated and tested variants has desired performance characteristics. This video can be used in a variety of ways, for example, this video can be used as the basis for further variants (e.g., generating additional options based on the video and optimizing those new options) or for the basis of a wider release of the video. For example, having determined that the generated video has desired performance characteristics as test on a particular media platform, the video can be published to several different media platforms or be further promoted now having it known that it has a certain desirable performance characteristics.

FIG. 6 illustrates an example process for determining performance of variants. In some examples, testing is performed until a threshold is reached. In some examples, the threshold is convergence of statistical significance. In another example, the threshold is a statistic regarding the content (e.g., a number of impressions or a percentage of audience members that reached 10 seconds of content view time) exceeding a predetermined value. This can prevent two good values that are not significantly different from wasting bandwidth or impressions. In that instance, one of the two values can be randomly selected as the “best” value.

The process 600 can begin by obtaining content to be tested 602. This can include, for example obtaining content created from multiple, different content variants (e.g., as generated in operation 508).

At operation 604, a batch of content is tested. This can involve uploading the content to a content distribution platform. Once uploaded, the content can be provided to audiences via the media distribution platform. During this time, the media description platform or another resource can collect statistics regarding performance of the content. Examples of these kinds of performance statistics have been previously discussed. This testing can be performed for a particular period. For example, the test can run for a determined period of time (e.g., 15 minutes or 24 hours), until a statistical threshold is reached (e.g., a particular number of events, such as indications that the content reached an audience member, reviews, impressions, likes, shares, etc.), and/or until the testing is manually stopped.

At operation 606 the probability of success for the tested variants is determined. For example, the Bernoulli success probability pᵢ can be estimated for the variants.

At operation 608, the variant with the highest success probability xᵢ^{best} can be selected from among the variants.

At operation 610, the chosen variants can be tested for statistical significance. A variety of approaches may be used to test for statistical significance, including a classical frequency approach or Bayesian approach to support very low rates. In an example, testing for statistical significance can involve, for example, xᵢ^{best} being tested for statistical significance to the other variants. For example, the null hypothesis can be that the probability of success for xᵢ^{best} is no better than the success probability of the other variants, and the alternate hypothesis is that xᵢ^{best} has a higher success probability than the others. In other words, this can be expressed as:

H₀:p_{best}≤pᵢ

H₁:p_{best}>pᵢ

If there is statistical significance, then that value can be chosen for the option and the process can continue with the next option. Otherwise, continue to the next batch unless another threshold is reached. Variants that are performing statistically significantly worse than Xᵢ^{best} can be disabled.

During the statistical analysis the binomial distributions can be approximated to normal distribution. In an example, the comparison of distributions can follow the rule that N*p>5 and N*(1−p)>5. In some examples, the distribution of X₁ can have a probability distribution expressed by: X₁˜Bin(N₁, P₁), with μ₁=P₁ and σ₁²=P₁(1−P₁). In some examples, the probability of success can be approximated using the number of actions taken compared to the number of views of the content. For example, in some examples of the probability of success can be approximated based on the number of interactions (e.g., accessing a link or an advertisement) compared to the number of impressions the content received. For instance, where the interactions are clicks, this can be expressed as

$$= \frac{clicks}{impressions} .$$

In other examples, the probability of success can be measured as unique clicks divided by the number of times (e.g., indications of a number of times) that the content reached an audience member. In other examples, a different action can be viewed assist as a success, such as receiving a like, receiving a share, or receiving another kind of action. The population variants can be approximated using the following equation:

$$= \frac{{P}_{1} ( 1 - {P}_{1} )}{N} .$$

For a sampling distribution of P₁−P₂, the mean can be expressed as μ_{P}_{₁}_{-P}_{₂}=P₁−P₂. The population variants can be approximated as:

$$= \frac{{P}_{1} ( 1 - {P}_{1} )}{{N}_{1}} + \frac{{P}_{2} ( 1 - {P}_{2} )}{{N}_{2}} \geq {σ}_{{P}_{1} - {P}_{2}} = \sqrt{\frac{{P}_{1} ( 1 - {P}_{1} )}{{N}_{1}} + \frac{{P}_{2} ( 1 - {P}_{2} )}{{N}_{2}}} .$$

To determine whether is [symbol] − [symbol] is 95% confident around μ_{P}_{₁}_{-P}_{₂}, the following equation can be used for the lower endpoint: μ_{P}_{₁}_{-P}_{₂}−1.96*σ_{P}_{₁}_{-P}_{₂} and the following equation can be used for the upper endpoint: μ_{P}_{₁}_{-P}_{₂}+1.96*σ_{P}_{₁}_{-P}_{₂}.

For hypothesis testing, the null hypothesis can be that there is no effect: H₀: P₁=P₂≥P₁−P₂=0 and the alternative hypothesis is that there is an effect: H₁: P₁>P₂≥P₁−P₂>0. To determine if the null hypothesis can be rejected, it can be determined whether: ( [symbol] − [symbol] |H₀)<0.05. If so, then H₀ can be rejected. The Z score can be expressed as

$$Z = \frac{( - ) - 0}{{σ}_{{P}_{1} - {P}_{2}}} ,$$

where as

$${P}_{1} = {P}_{2} , \\ {σ}_{{P}_{1} - {P}_{2}} = \sqrt{\frac{{P}_{1} ( 1 - {P}_{1} )}{{N}_{1}} + \frac{{P}_{2} ( 1 - {P}_{2} )}{{N}_{2}}} with$$

$${P}_{1} = \frac{{Success}_{1} + {Success}_{2}}{{N}_{1} + {N}_{2}} .$$

At operation 612, if the chosen variant is statistically significantly the best performer, then the flow can move to operation 616. If it is not, then the flow can move to operation 614.

At operation 614, a new batch of content can be selected. For example, the next batch of content can be chosen. With the chosen new batch, the flow can move to operation 604 where the batter content is tested.

At operation 616, results of this analysis can be provided. As part of this process, variants that are performing statistically significantly worse than Xᵢ^{best} can be removed from consideration as part of future analyses. This can help speed up the analysis process. As part of providing results, the best value for the given option, can be used in future analyses when selecting future additional options. For example, the statistical analysis in process 600 can be performed as part of testing the performance of the content and operation 510 of FIG. 5. The results of operation 616 may indicate that a particular value is statistically the best value to be used for a given option. This value can be used in future analyses of process 500. For example, having found a statistically significantly best value for a given option, that value can be used for that option going forward when testing variants in process 500. For example, the initial variant can be updated with a value for that option to be the statistically significant value for that option.

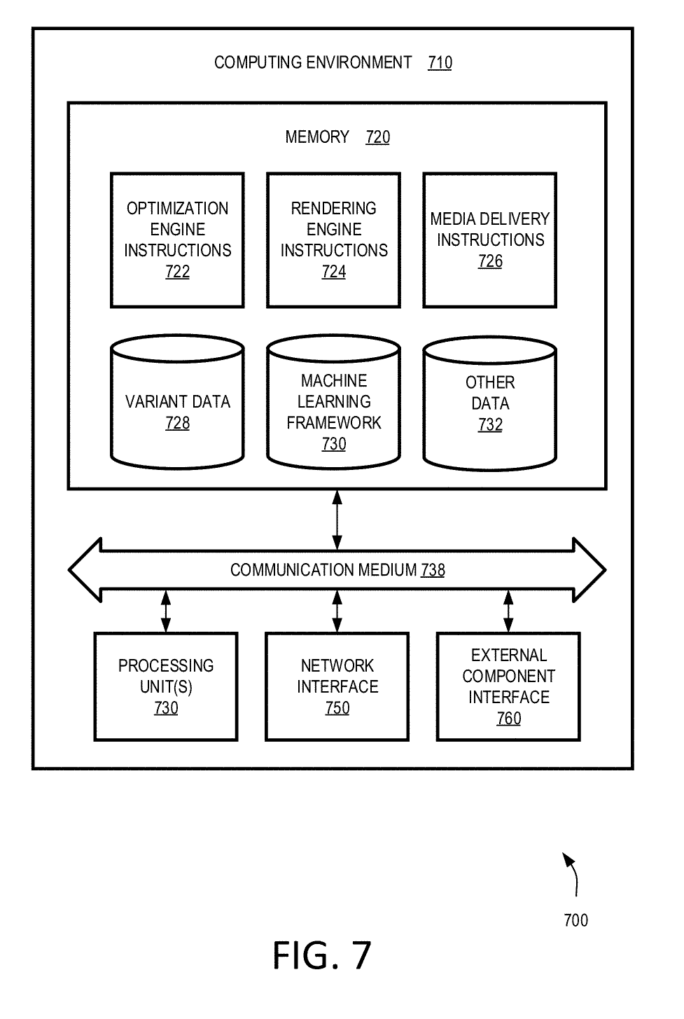

FIG. 7 illustrates an example system 700 with which disclosed systems and methods can be used. In an example, content author device 10, audience devices 40, optimization platform 110, and the media-delivery platform 130 can be implemented as one or more systems 700 or one or more systems having one or more components of systems 700. In an example, the system 700 can include a computing environment 710. The computing environment 710 can be a physical computing environment, a virtualized computing environment, or a combination thereof. The computing environment 710 can include memory 720, a communication medium 738, one or more processing units 740, a network interface 750, and an external component interface 760.

The memory 720 can include a computer readable storage medium. The computer storage medium can be a device or article of manufacture that stores data and/or computer-executable instructions. The memory 720 can include volatile and nonvolatile, transitory and non-transitory, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data.

The memory 720 can store various types of data and software. For example, as illustrated, the memory 720 includes optimization engine instructions 722 for implementing one or more aspects of content optimization described herein (e.g., as described in relation to optimization engine 112), rendering engine instructions 724 for implementing one or more aspects of rendering as described herein (e.g., as described in relation to the content rendering engine 114), media-delivery instructions 726 for controlling the delivery of media (e.g., to or from the media-delivery platform 130), variant data 728 for storing data associated with variants as described herein (e.g., storing authored content or rendered variants), a machine learning framework 730 for implementing one or more machine learning aspects described herein, as well as other data 732.

The communication medium 738 can facilitate communication among the components of the computing environment 710. In an example, the communication medium 738 can facilitate communication among the memory 720, the one or more processing units 740, the network interface 750, and the external component interface 760. The communications medium 738 can be implemented in a variety of ways, including but not limited to a PCI bus, a PCI express bus accelerated graphics port (AGP) bus, a serial Advanced Technology Attachment (ATA) interconnect, a parallel ATA interconnect, a Fiber Channel interconnect, a USB bus, a Small Computing system interface (SCSI) interface, or another type of communications medium.

The one or more processing units 740 can include physical or virtual units that selectively execute software instructions. In an example, the one or more processing units 740 can be physical products comprising one or more integrated circuits. The one or more processing units 740 can be implemented as one or more processing cores. In another example, one or more processing units 740 are implemented as one or more separate microprocessors. In yet another example embodiment, the one or more processing units 740 can include an application-specific integrated circuit (ASIC) that provides specific functionality. In yet another example, the one or more processing units 740 provide specific functionality by using an ASIC and by executing computer-executable instructions.

The network interface 750 enables the computing environment 710 to send and receive data from a communication network (e.g., network 140). The network interface 750 can be implemented as an Ethernet interface, a token-ring network interface, a fiber optic network interface, a wireless network interface (e.g., WI-FI), or another type of network interface.

The external component interface 760 enables the computing environment 710 to communicate with external devices. For example, the external component interface 760 can be a USB interface, Thunderbolt interface, a Lightning interface, a serial port interface, a parallel port interface, a PS/2 interface, and/or another type of interface that enables the computing environment 710 to communicate with external devices. In various embodiments, the external component interface 760 enables the computing environment 710 to communicate with various external components, such as external storage devices, input devices, speakers, modems, media player docks, other computing devices, scanners, digital cameras, and fingerprint readers.

Although illustrated as being components of a single computing environment 710, the components of the computing environment 710 can be spread across multiple computing environments 710. For example, one or more of instructions or data stored on the memory 720 maybe stored partially or entirely in a separate computing environment 710 that is accessed over a network.

While there have been described herein what are to be considered exemplary and preferred embodiments of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

We claim:

1. A method for generating video content, comprising:
obtaining authored content;
generating a first content variant based in part on the authored content;
rendering a first video output based on the first content variant;
receive performance statistics associated with audience reception to the first video output;
using a machine learning framework to generate a second content variant based in part on the performance statistics; and
rendering a second video output based on the second content variant.

2. The method of claim 1, further comprising: providing the first video output to a media-delivery platform, wherein the performance statistics are received from the media-delivery platform.

3. The method of claim 1, wherein the machine learning framework is configured to optimize with respect to a goal associated with an audience.

4. The method of claim 1, wherein using the machine learning framework to generate the second content variant comprises applying a greedy algorithm.

5. The method of claim 4, wherein the greedy algorithm is a discrete hill climbing algorithm.

6. The method of claim 1, wherein using the machine learning framework to generate a second content variant comprises applying an evolutionary algorithm.

7. The method of claim 1, wherein the first content variant is generated using a subset of the authored content.

8. The method of claim 7, wherein the first content variant comprises a first video clip of the authored content and not a second video clip of the authored content.

9. A computer-implemented method comprising:
generating a plurality of content variants;
rendering content items for each of the plurality of content variants;
uploading the rendered content items to a media-distribution platform;
obtaining performance statistics regarding performance of the uploaded content;
providing the performance statistics as input to a machine learning framework;
generating at least one new content variant based on output of the machine learning framework; and
uploading the at least one new content variant to the media-distribution platform.

10. The method of claim 9, further comprising obtaining authored content, wherein the plurality of content variants are generated based on the authored content.

11. The method of claim 10, wherein the content variants each comprise a subset of the authored content.

12. The method of claim 9, further comprising: deactivating an uploaded content item on the media-distribution platform responsive to determining that the uploaded content item is a poor performing content item.

13. The method of claim 9, further comprising waiting for a statistically significant convergence prior to providing the performance statistics as input to the machine learning framework.

14. The method of claim 9, further comprising waiting for a number of events to exceed a threshold and for a minimum time period prior to providing the performance statistics as input to the machine learning framework.

15. A computer-implemented method comprising:
obtaining authored content comprising a plurality of options, each option having a plurality of possible values;
for each option of the plurality of options, selecting a value from the respective plurality of possible values;
generating an initial video variant based, in part, on the possible values;
selecting a first option of the initial video variant;
generating a new variant for each of the plurality of possible values of the option; and
rendering a plurality of videos using the generated new variants.

16. The method of claim 15, further comprising testing the performance of the plurality of videos.

17. The method of claim 16, wherein testing the performance of the plurality of videos comprises: determining whether a video of the plurality of videos has a statistically significant probability of success with respect to a predetermined goal.

18. The method of claim 15, further comprising:
responsive to determining that a video of the plurality of videos has a statistically significant probability of success, selecting a second value associated with a second option of the video; and
setting the second option of the initial video variant to the second value.

19. The method of claim 15, wherein selecting the value from the plurality of possible values comprises selecting the value at random.

20. The method of claim 15, further comprising:
rendering an initial video based on the initial video variant; and
obtaining statistics regarding the performance of the initial video.
